(19) United States
(12) Patent Application Publication
(10) Pub. No.: US 2023/0028115 A1
(43) Pub. Date: Jan. 26, 2023

(54) FORMULATION COMPRISING STREPTOMYCES SPP. FOR USE IN SEED TREATMENT

(71) Applicant: DANSTAR FERMENT AG, Zug (CH)

(72) Inventor: Endrick Guy, Angers (FR)

(73) Assignee: DANSTAR FERMENT AG, Zug (CH)

(21) Appl. No.: 17/782,436

(22) PCT Filed: Dec. 4, 2020
(86) PCT No.: PCT/EP2020/084752

§ 371 Date: Jun. 3, 2022

(30) Foreign Application Priority Data
Dec. 5, 2019 (EP) 19306585.1

(51) Int. Cl. A01N 63/28; A01P 3/00

(52) U.S. Cl. CPC A01N 63/28; A01P 3/00

(57) ABSTRACT

The present disclosure provides a method for improving the survival and viability of Streptomyces spp. spores on coated seeds.

### TECHNOLOGICAL FIELD

The present disclosure relates to a seed treatment, and more particularly, to methods for the inoculation of seeds with the beneficial microorganism Streptomyces spp.

### BACKGROUND

There is increasing interest in the use of beneficial microorganisms as alternatives to chemical pesticides and synthetic fertilisers in agricultural production. One strategy for delivering microorganisms to the rhizosphere is by seed inoculation prior to planting. Indeed, application of beneficial microorganisms to seeds is an efficient mechanism for placement of microbial inocula into soil where they will be well positioned to colonise seedling roots and protect, amongst other, against seed/soil-borne diseases and pests. The need for formulations that support viability and quality of beneficial microorganisms (i.e. biocontrol agents) has been identified as a limiting factor in the development of this type of technology.

Streptomycetes are Gram positive, filamentous bacteria in the Streptomycetaceae family (Phylum Actinobacteria, Order Actinomycetales), with the genus Streptomyces as the sole member and more than 500 species. They are widely distributed in soil (nearly 40% of soil bacteria) and rhizosphere, where they form very dynamic assemblies. Streptomyces spp. is a bacterium that is used as a microbial pest control agent for the suppression, for example, of damping-off, root and crown rot, and wilt in various greenhouse ornamentals, vegetables, and herbs caused by common pathogenic fungi. In other words, Streptomyces spp. is an interesting biocontrol agent against a wide range of phytopathogenic fungi, which is not surprising given its ability to produce various bioactive compounds. It also promotes plant growth and induces plant defense mechanisms.

The commercial end-use product comprising Streptomycetes or any other biocontrol agents is often formulated as a wettable powder and is applied as a water suspension directly to the root zone/growing media of greenhouse plants. It can also be used as a seed treatment and is applied as a powder directly to seeds. More particularly, the powder is mixed with seeds on-farm; the farmer mixes the powder and the seeds together (by any method known in the art) just before or during its loading into planting equipment. The general recommendation is that such a seed is planted within a few hours of inoculation. The production of such an inoculated seed presents an extra step for the farmer, contributes to the complexity of the farming process and is usually dislike by farmers. Indeed, farmers are often under severe time constraint during crop sowing periods and do not have time to treat seeds themselves. Moreover, this application as a powder directly to seeds leads to a low loading of viable and stable microorganism, an uneven distribution of the microorganisms (e.g. spores) on seeds and present an insufficient shelf-life. It would be preferable if pretreated seeds with stable, viable inoculum of microorganisms were available for growers, as is usually the case for seeds treated with agrochemicals. However, in most cases, survival of microorganisms on seed coatings is poor.

Accordingly, with the disadvantages described above there is a need for a new formulation for biocontrol agents, such as Streptomyces spp., suitable for seed treatment or to be coated on seeds. Such formulation has to provide an increased on-seed survival and stability of the biological control agents, such as Streptomyces spp., exhibit a suitable shelf life over time and ensure a superior distribution of the biological agent on seeds.

### BRIEF SUMMARY

The invention provides a method of preparing coated seeds, comprising slurrying seeds and spores of Streptomyces spp produced by solid-state fermentation of the Streptomyces spp.

The invention further provides a method for controlling seed-borne pathogens or phytopathogenic microorganisms, comprising preparing coated seeds as described above, and planting said resulting coated seeds.

In an embodiment of the invention, the Streptomyces spp remain substantially stable for at least one month after coating. In a further embodiment, the slurry comprises at least one adhesive polymer in an aqueous suspension. The adhesive polymer may be polyvinyl alcohol, polyvinyl alcohol copolymer, methylcellulose, hydroxymethyl cellulose, hydroxymethylpropylcellulose, dextrin, alginate, polyvinylpyrrolidone, polyethylene glycol, vinyl acetate, protein, fats, oils, or any combination thereof.

In an embodiment of the invention, the spores of Streptomyces spp. are applied simultaneously with the seeds and an aqueous suspension comprising at least one seed coating agent. In an alternative embodiment, the pores of Streptomyces spp. are applied after slurrying together the seeds with an aqueous suspension comprising at least one seed coating agent. The method may further comprises drying the resulting coated seeds. The aqueous suspension as described above may comprise 1% to 55% by weight of the adhesive polymer.

In an embodiment of the invention, the concentration of Streptomyces spp. spores coated on seeds is from about 1×10⁴ to 1×10⁸ CFU/seeds. In a further embodiment, the seeds are vegetable seeds, cereal seeds, fruit seeds or leguminous plant seeds.

In one embodiment, the coated seeds with spores of Streptomyces spp. achieve the same fungicide potency as synthetic chemical product coated on seeds. The coated seeds with spores of Streptomyces spp. may achieve the same fungicide potency as thiram coated on seeds. The coated seeds with spores of Streptomyces spp. may achieve the same fungicide potency as thiram coated on seeds against fungal infection caused by seed-borne pathogens. The seed-born pathogen is Phoma valerianellae. In a further embodiment, the coated seeds with spores of Streptomyces spp. achieve the same fungicide potency as synthetic chemical product coated on seeds against Fusarium oxysporum, Rhizoctonia solani, Pythium ultimum, Alternaria brassicicola or Didymella bryoniae.

The invention further provides a seed coated with spores of Streptomyces spp. produced by solid-state fermentation of the Streptomyces spp, optionally wherein the seed is obtainable by the method described above. In one embodiment, said coating comprises an adhesive polymer which is polyvinyl alcohol, polyvinyl alcohol copolymer, methylcellulose, hydroxymethyl cellulose, hydroxymethylpropylcellulose, dextrin, alginate, polyvinylpyrrolidone, polyethylene glycol, vinyl acetate, protein, fats, oils, or any combination thereof.

The invention further provides a liquid suspension for coating seeds, comprising spores of at least one Streptomyces spp. produced by solid-state fermentation of Streptomyces spp.

The invention further provides the use of a coated seed comprising spores produced by solid-state fermentation of Streptomyces spp for preventing or reducing the presence of crop pathogens.

The invention further provides the use of spores produced by solid-state fermentation of Streptomyces spp for the preparation of seeds coated with Streptomyces spp. spores.

The invention further provides the use of spores produced by solid-state fermentation of Streptomyces spp for enhancing the stability or viability of Streptomyces spp. spores coated on seeds.

The invention further provides the use of a coated seed comprising spores produced by solid-state fermentation of Streptomyces spp for enhancing stability of Streptomyces spp. spores.

In one embodiment, the seed coated with spores as described above is obtainable by the methods described above. In one embodiment, the Streptomyces spp is the Streptomyces spp. strain K61 (deposited under accession number DSM 7206). In a further embodiment, the spores are dry spores, optionally wherein the Streptomyces spp is the Streptomyces spp. strain K61 (deposited under accession number DSM 7206).

In a first aspect, the present disclosure is directed to a method of preparing coated seeds which comprises slurrying (1) seeds, (2) an aqueous suspension comprising at least one seed treatment agent and (3) dry spores of Streptomyces spp.

In a second aspect, the present disclosure is directed to a method for controlling seed-borne pathogens or phytopathogenic microorganisms comprising preparing coated seeds according to the first aspect described above, and planting said resulting coated seeds, wherein the at least one seed treatment agent comprises an adhesive polymer which is polyvinyl alcohol, polyvinyl alcohol copolymer, methylcellulose, hydroxymethyl cellulose, hydroxymethylpropylcellulose, dextrin, alginate, polyvinylpyrrolidone, vinyl acetate, protein, fats, oils, or any combination thereof.

In an aspect of the present disclosure, the at least one seed treatment agent is at least one adhesive polymer. In another aspect of the disclosure, the adhesive polymer is polyvinyl alcohol, polyvinyl alcohol copolymer, methylcellulose, hydroxymethyl cellulose, hydroxymethylpropylcellulose, dextrin, alginate, polyvinylpyrrolidone, vinyl acetate, protein, fats, oils, or any combination thereof. In an aspect of the disclosure, the (3) dry spores of Streptomyces spp. are applied simultaneously with the (1) seeds and the (2) aqueous suspension comprising at least one seed treatment agent. In another aspect of the disclosure, the (3) dry spores of Streptomyces spp. are applied after slurrying together the (1) seeds with (2) the aqueous suspension comprising at least one seed treatment agent. In still another aspect of the disclosure, the method of the present disclosure further comprises drying the resulting coated seeds. In an aspect of the disclosure, the aqueous suspension comprises 1% to 55% by weight of the adhesive polymer. In an aspect of the disclosure, the concentration of Streptomyces spp. spores coated on seeds is from 1×10⁴ to 1×10⁶ CFU/seeds. In another aspect of the disclosure, the seeds are vegetable seeds, cereal seeds, fruit seeds or leguminous plant seeds. In another aspect of the disclosure, the coated seeds with dry spores of Streptomyces spp. achieve the same fungicide potency as synthetic chemical product coated on seeds. More particularly, the coated seeds with dry spores of Streptomyces spp. achieve the same fungicide potency as thiram coated on seeds against, for example, fungal infection caused by seed-borne pathogens. In an aspect of the disclosure, the seed-born pathogen is Phoma valerianellae.

In a third aspect, the present disclosure is directed to a seed coated with dry spores of Streptomyces spp. and at least one seed treatment agent wherein said at least one seed treatment agent comprises an adhesive polymer which is polyvinyl alcohol, polyvinyl alcohol copolymer, methylcellulose, hydroxymethyl cellulose, hydroxymethylpropylcellulose, dextrin, alginate, polyvinylpyrrolidone, vinyl acetate, protein, fats, oils, or any combination thereof.

In another aspect, the disclosure provides the use of spores produced by solid-state fermentation of Streptomyces spp for enhancing the stability of seeds coated with Streptomyces spp. spores.

### FIGURES

Having thus generally described the nature of the invention, reference will now be made to the accompanying drawings, showing by way of illustration, a preferred embodiment thereof, and in which:

FIGS. 1A and B illustrate the percentages of germination (A) and homogeneity (B) of four corn salad varieties at 7 days post-sowing at 4° C.

FIG. 2 illustrates the percentage of germination of four corn salad varieties at 7 days post-sowing at 15° C.

FIGS. 3A and B illustrate the germination rate of four different corn salad varieties in a non-contaminated soil (A) and in contaminated soil with P. valerianellae (B) at 9 days post-sowing.

FIG. 4 illustrates the on-seed stability of Streptomyces K61 in function of time.

### DETAILED DESCRIPTION

The present disclosure provides stable seed coating compositions and methods for enhancing the survival, the viability and/or stability of microbial spores on coated seeds.

It has been found that slurrying seeds with a liquid suspension comprising spores or dry spores of Streptomyces spp. results in a coated seed product with adequate Streptomyces spp. numbers per seed and in which sufficient Streptomyces spp. remain viable for a period in excess of 5 months, for example at least 12 months, at room temperature (i.e. 25° C.). This is important because refrigeration is often not possible along the supply chain and is very expensive.

Furthermore, the method of treating or coating seeds with Streptomyces spp. developed in the present disclosure allows control on the pathogen attack and achieves the same fungicidal or efficacy as known synthetic chemical products on common pathogenic fungi.

In an embodiment, the present disclosure relates to a method of preparing coated seeds with spores of Streptomyces spp. comprising, prior to sowing, slurrying seeds with a liquid suspension comprising spores or dry spores of at least one Streptomyces spp. strain having a beneficial effect on plants. The liquid suspension preferably further comprises at least one seed treatment or coating agent. In some embodiments, the treated or coated seeds. i.e. the resulting products, can be dried according to various methods known in the art. In another embodiment, a liquid suspension comprising spores of at least one Streptomyces spp. strain and at least one seed treatment or coating agent is provided.

The methods and uses described herein provide for stability of microorganisms, particularly on-seed stability, survival and viability of microorganisms, including enhanced stability, survival and viability of microorganisms. The seeds and liquid suspensions of microorganisms described herein may also be described as comprising stable microorganisms or microorganisms with enhanced survival or stability. Preferred stabilities and survival and viability characteristics are described below.

All strains of Streptomyces spp. having plant beneficial properties can be used in the present disclosure. In an embodiment, the microorganism is Streptomyces spp. (former Streptomyces griseoviridis) strain K61 (or also referred to as Streptomyces K61) (which can be isolated from the product Mycostop®, Lallemand). More particularly, Streptomyces sp. K61 was deposited on 14 Aug. 2020 according to the Budapest Treaty under accession number DSM 7206 at the Deutsche Sammlung von Mikroorganismem and Zellkulturen GmbH (DSM) (Mascheroder Weg 1 B, D-3300 Braunschweig, Germany).

Spores of Streptomyces spp. according to the present disclosure and in particular the specific strain mentioned above may be conveniently produced by solid-state fermentation using any suitable methods known to the person skilled in the art. As used herein, the terms “spore” refers to a microorganism in its dormant, protected state. Interestingly, the production of the spores of Streptomyces sp. (such as Streptomyces sp. K61) by solid state fermentation and used in the seed coating of the present disclosure results in greater on-seed stability and spore survival or viability than mycelium and spores conventionally produced by liquid submerged fermentation and used for dusting seeds just before planting. Indeed, as known in the art, the fungal propagules produced by liquid submerged fermentation comprise mixtures containing a high proportion of mycelium relative to quantity of spores which fungal propagules (i.e. mycelium and spores) tend to be very unstable and have a very short shelf life. Typically, the spores produced by solid-state fermentation according to the disclosure are in dry form when integrated into a seed coating. The spores produced by solid-state fermentation according to the disclosure may alternatively be present in a liquid suspension, such as an oil suspension, prior to integration into a seed coating.

As used herein, the term “stable” refers to a seed coating composition or coated seed in which microorganisms (i.e. spores) exhibit enhanced stability and/or enhanced survival. In general, a seed coating composition may be defined or labeled “stable” if it improves the survival rate and/or at least on one microbial stability characteristic of the microorganism comprised or included in the seed coating as compared to a control (e.g. a control composition that is identical to the seed coating composition of the present disclosure except the method of production of the microbial spores). For example, a microorganism that exhibits a greater viability after being coated on a seed and stored for a defined period of time compared to a control microorganism (e.g. a control composition that is identical to the seed coating composition of the present disclosure except the method of production of the microbial spores being liquid submerged fermentation instead of solid state fermentation) when each is subjected to the same conditions displays enhanced stability and can be referred to as “stable”. In other words, the term “stability” as used herein relates to the ability of the microorganisms (i.e. spores) of maintaining viability over a certain period of time as, for example during storage when applied to seeds. The stability described herein may also be referred to as on-seed stability.

A microorganism (i.e. spores) may exhibit greater stability, survival and/or viability after being coated on a seed than a control microorganism after being stored for at least 6 hours, at least 12 hours, at least 24 hours, at least 48 hours, at least 1 week, at least 15 days, at least 30 days, at least 4 months, at least 5 months, at least 6 months or at least 12 months. A microorganism (i.e. spores) may exhibit greater stability, survival and/or viability after being coated on a seed than a control microorganism, when stored at at least 15° C., preferably when stored at at least 25° C. (e.g. room temperature), or when stored at at least 30° C. A microorganism (i.e. spores) may exhibit greater stability, survival and/or viability after being coated on a seed than a control microorganism after being stored at, for example, at about 25° C. for at least 1 week, at about 25° C. for at least 4 months, at about 25° C. for at least 6 months, at about 25° C. for at least 12 months, at about 15° C. for at least 1 week, at about 15° C. for at least 15 days, at about 15° C. for at least 30 days, at about 15° C. for at least 4 months, at about 15° C. for at least 6 months, at about 15° C. for at least 12 months, at about 30° C. for at least 6 hours, at about 30° C. for at least 24 hours, at about 30° C. for at least 48 hours, at about 30° C. for at least 15 days, or at about 30° C. for at least 30 days. Preferably, a microorganism may exhibit greater stability, survival and/or viability after being coated on a seed than a control microorganism after being stored at 25° C. for at least 15 days, more preferably at least 6 months, or greater.

As used herein, the term “enhanced survival” refers to an improvement in the survival rate of one or more microorganisms (i.e. spores) in a seed coating composition as compared to one or more microorganisms in a control composition (e.g., a control composition that is identical to the seed coating composition of the present disclosure except the method of production of the microbial spores). A seed coating composition or coated seed that improves the survival rate of one or more of the microorganisms comprised or contained therein as compared to a control composition (e.g., a control composition that is identical to the inoculant composition except the method of production of the microbial spores being liquid submerged fermentation instead of solid state fermentation) provides enhanced survival and can be referred to as a stable inoculant composition or stable coated seed. In the context of the present disclosure, the term “enhanced survival” means retaining a concentration of viable microorganisms (i.e. spores) in a seed coating composition as close as possible to the concentration just after the manufacture of the coated seeds during a determined storage period at a determined temperature over survival rate which would be obtained by a control which is different only in the method of production of the microbial spores (i.e. liquid submerged fermentation instead of solid state fermentation).

Further, as used herein with respect to microbial spores or microorganisms, the term “survival rate” refers to the percentage of microbial spores that are viable (i.e., capable of propagating on or in a substrate when conditions (e.g., temperature, moisture, nutrient availability, pH, etc.) are favorable for microbial growth) at a given period of time. It denotes their status to be alive. Indeed, spore viability is measured, for example, by removing a suitable portion of coated seeds from a package after a storage period and determining the number of viable microorganisms on a growth medium suitable for the particular microorganism. Viability can be measured by many different ways as it is known in the art. The viability is expressed as colony forming units (CFU) per ml, per gram, or per seed. The survival described herein may also be referred to as on-seed survival.

In the context of the present disclosure, the term “enhancing stability” means, amongst other, that the population of microorganisms (i.e. spores) retain sufficient viability and survival rate during the storage once applied on seeds. The loss of viable spores coated on seeds during storage, when produced by solid-state fermentation, may be no more than 0.1 log CFU, 0.2 log CFU, 0.3 log CFU, 0.4 log CFU, 0.5 log CFU, 0.6 log CFU, 0.7 log CFU, 0.8 log CFU, 0.9 log CFU, 1 log CFU, 1.1 log CFU, 1.2 log CFU, 1.3 log CFU, 1.4 log CFU, 1.5 log CFU, 1.6 log CFU, 1.7 log CFU, 1.7 log CFU, 1.8 log CFU, 1.9 log CFU, 2 log CFU, 2.1 log CFU, 2.2 log CFU, 2.3 log CFU, 2.4 log CFU or 2.5 log CFU during storage, for example when compared to a corresponding population of microorganisms (i.e. spores) on coated seeds on initial coating, such as measured on the day of coating. The loss of viable spores is reduced according to the invention compared to that observed with a corresponding population of microorganisms (i.e. spores) on coated seeds produced by liquid submerged fermentation instead of solid-state fermentation. An above loss of viable spores may be calculated over any suitable period of time described herein, preferably at least 6 months or at least 12 months. Typically, the loss of viable spores may be calculated when the coated seeds are stored at at least 15° C., such as 25° C. (room temperature).

Typically, the concentration of viable spores after storage of the coated seeds according to the present disclosure is at least 5×10³ CFU/seed, such as at least 1×10⁴ CFU/seed. Typically, the concentration of spores on coated seeds is at least 1×10⁴ CFU/seed, such as 1×10⁵ CFU/seed after 30 days of storage at 25° C.

Typically, the population of microorganisms (i.e. spores) of the present disclosure is coated on the seeds at a concentration of 1×10⁸ CFU/gram, such as 1×10⁷ to 1×10⁹ CFU/gram, or 1×10⁸ to 1×10¹¹ CFU/gram. The population of microorganisms (i.e. spores) of the present disclosure may be coated on the seeds at a concentration of 1×10³ to 1×10⁷ CFU/gram. The number of colony forming units per coated seed depends on many factors, including the size and type of the coated seeds, the coating agents used, and the length of time that the seeds are slurried with the spores and/or coating agents.

Typically, the seeds coated with the population of microorganisms (i.e. spores) of the present disclosure initially have, for example after coating, between 1×10³ to 1×10⁸ CFU/seed, such as 1×10⁴ to 1×10⁶ CFU/seed, about 1×10⁵ CFU/seed or 1×10⁶ CFU/seed.

The seeds coated using the one or more microorganisms (i.e. spores) of the present disclosure may provide control of pathogens for an enhanced duration of time as compared to one or more microorganisms in a control composition (e.g., a control composition that is identical to the seed coating composition of the present disclosure except the method of production of the microbial spores). A seed coated using the spores of the present disclosure may retain ability to reduce or prevent the presence of crop pathogens for a longer period as compared to a control seed (e.g. a control composition that is identical to the seed coating composition of the present disclosure except the method of production of the microbial spores).

A “control composition” as described herein may be a composition wherein the microbial spores are produced by liquid submerged fermentation.

For example, solid state production of Streptomyces spp. spores may be achieved by inoculating a solid substrate such as a peat or vermiculite-based substrate, or grains including, but not limited to, oats, wheat, barley, or rice. The sterilized substrate is inoculated with a cell suspension (such as 1×10² to 1×10⁷ CFU/g or 1×10² to 1×10⁸ CFU/g) of the appropriate Streptomyces spp. strain and the moisture is adjusted depending on the substrate (10% to 60%). The material is incubated for 1 to 4 weeks at appropriate temperature until a visible spore formation occurs. The colonized material may be dried before the separation of spores, mycelial and vegetative hyphae cells using methods known in the art as, for example, air drying, freeze drying or fluid bed drying techniques. The spores, mycelial and vegetative hyphae cells are separated from the solid substrate by different methods known in the art as washing, polishing, sieving, pushed airflow, to obtain a concentrated product comprising spores, mycelium and hyphae cells. Suitable separation and cleaning methods are known in the art.

The resulting material (i.e. spores, mycelium and vegetative hyphae cells with a higher concentration of spores) may be further concentrated by different methods known in the art as sieving, filtering, cyclone concentration or centrifugation, then formulated, and, if needed, dried using methods known in the art such as air drying, freeze drying, or fluid bed drying techniques to produce a powder or preparation comprising spores.

More particularly, the spore production of Streptomyces spp. K61 by solid-state fermentation is achieved as follows. A solid substrate such as rice, is immersed in water and then packed into autoclave bags. The autoclave bags with the prepared substrate are autoclaved at 121° C. for 40 minutes. Each bag is then inoculated with a seed culture of Streptomyces K61 and incubated for five to ten days at 27° C. Once the solid substrate such as rice is well colonized by the bacteria which had almost completely sporulated, the colonized substrate is spread on trays for drying for two to three days at 25 to 28° C. Once the colonized rice substrate is dried, the spores are harvested and then concentrated, filtrated and separated from rice residues on a vibrating screen in order to eliminate rice residues.

The preparation comprising spores may then be mixed with at least one seed treatment or coating agent in a liquid suspension and before application to the surface of seeds. It will be understood that the treatment with Streptomyces spp. spores can be done after said seed has been treated with another seed treatment or coating agent, cleaned or disinfected according to methods known in the art. In the liquid suspension according to the present disclosure at least one or more seed treatment or coating agents may be present. As used in the present disclosure, the term “coating” denotes any process that endows the outer surfaces of the seeds partially or completely with a layer or layers of non-plant material. In general, according to this method, the seeds are cleaned and afterwards coated with a seed coating treatment or formulation or composition comprising spores produced by solid state fermentation by using any coating techniques and machines used in the art for about several seconds to several minutes. Afterwards, the seeds can be dried.

The liquid suspension, formulation or composition applied to the seeds may contain one or more seed treatment or coating agents which comprise all agents that could be applied to seeds prior to sowing and may be for example plant protection agents in different formulation types, plant growth promoting agents, seed coating agents or inoculants. In an embodiment, the seed treatment agent is a seed coating agent in a formulation or composition which is compatible with the microorganism (i.e. with Streptomyces spp.). For example, a formulation or composition referred to as coating agents may comprise one or more components which components include, but are not limited to, other pesticides (such as fungicides, acaricides, miticides, insecticides, insect repellents, bird repellents, rodenticides, molluscicides, nematicides, bactericides, and fumigants), herbicides, adjuvants, wetters, nutrients, waxes, anti-oxidation agents, gene activators protective colloids, surfactants, minerals, chemical hybridizing agents, pigments, auxins, sticking or binding agents, antibiotics and other drugs, biological attractants, colorants, dispersing agents, solvents, solid carriers, growth regulators, pheromones, thickening agents, dyes, safeners, fertilizers, anti-freeze agents, biocontrol agents (e.g. naturally-occurring or recombinant bacteria and/or fungi), liquid diluents, binders, fillers (e.g. fine powders of organic or mineral type for protecting the seeds during stress conditions), plasticizers (to improve flexibility, adhesion, and/or spreadability), drying agents, solubilizers, dispersing agents, anti-foaming agents.

In an embodiment, the liquid suspension, formulation or composition of the present disclosure and applied to the seeds comprises a “binding or sticking agent” such as a filler or a binder or an adhesive polymer or adhesive film over the seeds so that the spores produced by solid state fermentation can be bonded to the seeds to form a coating. For example, a quantity of seeds can be mixed with a binding or sticking agent and spores produced by solid state fermentation, and optionally agitated to encourage uniform coating of the seeds with the binding or sticking agent and spores. The formulation applied to seeds and comprising spores produced by solid state fermentation may comprise other components as discussed above.

In an embodiment, the seed coating agent comprises an adhesive polymer such as, but not limited to, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, polyethylene glycol, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof. Other suitable adhesive polymers include polymers and copolymers of vinyl acetate, methyl cellulose, vinylidene chloride, acrylic, cellulose, polyvinylpyrrolidone or polysaccharide. Still other suitable adhesive polymers include polymers or copolymers of vinylidene chloride and vinyl acetate-ethylene copolymers. In an embodiment, the adhesive polymers are polyvinyl alcohols, polyvinyl alcohol copolymers, methylcelluloses, hydroxymethyl celluloses, hydroxymethylpropylcelluloses, dextrins, alginate, polyvinylpyrrolidone, vinyl acetate, proteins, polyethylene glycol, fats, oils, or any combination thereof. In an embodiment, the coating agent comprises polyethylene glycol.

The liquid suspension of the present disclosure contains 1 to 55% by weight of adhesive polymer.

The proportion of Streptomyces spp. spores to seeds may be from about 0.02% to 20%, 0.04% to 15%, 0.05% to 12% or 1% to 10% by weight, depending of the type of seeds. The concentration of Streptomyces spp. spores coated on seeds may be from about 1×10³ to 1×10⁸, about 1×10⁴ to 1×10⁸, about 1×10⁴ to 1×10⁶, about 1×10⁵ to 1×10⁶, or about 1×10⁵ to 1×10⁷ CFU/seeds depending of the type of seeds.

In an embodiment, the dry formulation comprising of spores of Streptomyces spp. may be applied simultaneously or shortly after applying the liquid suspension to said seed, thereby wetting the seed in a sufficient manner and allowing the dry formulation comprising of spores of the Streptomyces spp. to adhere to the seed. In a preferred embodiment, the liquid suspension comprises at least one adhesive polymer.

The treatment of the present disclosure may be applied to the seeds at any time between harvest of the seeds and sowing of the seeds. The term “seed” as used herein means any resting stage of a plant that is physically detached from the vegetative stage of a plant. As used herein, the term “unsown seeds” is meant to include seed at any period between the harvest of the seed and the sowing of the seed in the ground for the purpose of germination and growth of the plant. In an embodiment, the seeds are typically treated in the timeframe between their harvest and before sowing them in a future vegetation period, preferably the following vegetation period.

When it is said that unsown seed is “coated” or “treated” with the suspension, such treatment is not meant to include those practices in which the suspension is applied to the soil or directly mixed on-farm just before sowing rather than to the seeds as presently described.

The formulation of the present disclosure may be applied to or coated on seeds by any standard seed treatment methodology known in the art. After coating, the seeds can be dried and then transferred to a sizing machine for sizing. Such procedures are known in the art.

In an embodiment, the coated seeds with spores of Streptomyces spp. (e.g. Streptomyces K61) produced by solid-state fermentation achieve the same fungicide potency as a synthetic chemical product (e.g. fungicide) coated on seeds against Phoma (e.g. Phoma valerianellae), Fusarium (e.g. Fusarium oxysporum), Rhizoctonia (e.g. Rhizoctonia solani), Pythium (e.g. Pythium ultimum), Alternaria (e.g. Alternaria brassicicola), Didymella, Macrophomina, Colletotrichum or Aphanomyces. Examples of fungicides contemplated by the present disclosure are thiram, metalaxyl or fludioxonil. In an embodiment, the coated seeds with spores of Streptomyces spp. (e.g. Streptomyces K61) achieve the same fungicide potency as thiram coated on seeds against Phoma valerianellae, Pythium ultimum, Alternaria brassicicola or Didymella bryoniae. The coated seeds with spores of Streptomyces spp. (e.g. Streptomyces K61) achieve the same fungicide potency as fludioxonil coated on seeds against Fusarium oxysporum or Rhizoctonia solani.

Useful for the present disclosure is the seeds of various cultivated plants, for example cereals such as wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, oil seed rape/canola, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e. g. conifers, preferably corn, sunflower, cereals such as wheat, rye, barley, triticale, oats or rice, soybean, cotton, oil seed rape/canola more preferably corn, sunflower, soybean, cereals such as wheat, rye, barley, triticale, oats or rice.

Coated seeds prepared by the method of the present disclosure preferably have the following advantages:
(a) The coated seeds are free flowing.
(b) The coating comprising spores of Streptomyces spp. (e.g. spores of Streptomyces spp. K61) produced by solid-state fermentation and at least one seed treatment or coating agent has no adverse effect on seed germination.
(c) The coated seeds maintain high numbers of viable Streptomyces spp. spores per seeds during a period of at least six months at room temperature (i.e. 25°). Shelf life of spores, in particular of Streptomyces spp., is measured by determining the amount of colony forming units (CFU) as known in the art.

The word “comprising” in the claims may be replaced by “consisting essentially of” or with “consisting of,” according to standard practice in patent law.

The following example serves to further describe and define the invention and is not intended to limit the invention in any way.

Materials and Methods

Production of Streptomyces strain K61 by liquid submerged fermentation (LSF) and solid-state fermentation (SSF)

Spore Production by Liquid State Fermentation (LSF):

Streptomyces K61 was inoculated into a culture medium comprising malt syrup and cultivated at 28° C. for 4 days (pH 6 and dissolved oxygen >20%). The bacterial biomass made of spores vegetative mycelium and hyphae cells of Streptomyces was harvested from the fermentation broth by centrifugation or filter press. The dry weight of the separated biomass was measured. Cryoprotective agents were added (sucrose 60%, carboxy-methyl-cellulose 5% and ascorbic acid 3%, dry weight basis), and mixed with the separated vegetative mycelium cells and spores. The formulated biomass slurry comprising spores was spread on freeze dryer shelves and frozen at about −50° C. before freeze-drying.

Spore Production by Solid-State Fermentation (SSF):

Rice was immersed in water and then packed into autoclave bags. The autoclave bags with the prepared substrate were autoclaved at 121° C. for 40 minutes. Each bag was inoculated with a seed culture of Streptomyces K61 and incubated for seven days at 27° C. Once the rice was well colonized by the bacteria which had almost completely sporulated, the colonized substrate was spread on trays for drying for three days at 25° C. After drying, the spores were harvested with a polisher and then concentrated by cyclone, filtrated and separated from rice residues on a vibrating screening order to eliminate rice residues.

### Example 1

The Aatiram 65 (CHEMINOVA A/S) is the reference plant protection product (PPP) used for this study. The Mycostop® (Lallemand Plant Care) product is a powder formulation based on Streptomyces strain K61 (Streptomyces K61).

The study was conducted on six different corn salad varieties.

All tests were performed under controlled conditions (phytotron). The Mycostop® product was compared to seeds treated only with the coating slurry without any PPP (binder) and to the reference chemical Aatiram 65 (Aatiram65).

Seed Coating:

The seed coating with Mycostop® was performed using a semi-industrial coater (SATEC). 5 g of Mycostop® per kg of seeds (dose 1N) were used to coat the corn salad seeds corresponding to the recommendation to this product (2-8 g per kg of seeds). Mycostop® is mixed with the adhesive polymer and coated on seeds.

The seed coating with Aatiram65 was performed according to the manufacturer recommendation. After the coating, the corn salad seeds are dried in an air dryer, let stand for one week and then used for the selectivity, efficacy and on-seed stability tests.

Selectivity Tests:

A germinating and homogeneity tests at cold conditions (10° C.) and temperate temperature (15° C.) on filter paper humidified by 16 ml of osmosis water with 16 hours of photoperiod was conducted. 300 seeds were used for the test.

Efficacy tests against Phoma valerianellae:

The efficacy tests were performed in soil artificially contaminated with P. valerianellae spores. The seeds were sown either in contaminated or clean soil. The clean soil served as control of germination rate without pathogen pressure for the seed lots used.

Detection of P. valerianellae in Corn Salad Seeds:

The detection of P. valerianellae in corn salad seeds was performed as described by GEVES protocol on Agar plate isolation on 1000 seeds.

Determination of the On-Seed Stability:

The on-seed stability of Streptomyces K61 was studied for a period of 6 months. The corn salad seeds were stored at room temperature. Two samples of seeds per time point were used to study the bacterial population on-seed. The seeds were resuspended in a buffer and the supernatant was used to prepare serial dilutions. The dilutions were plated on the PDA medium and the colonies were expressed as colony-forming units per seed (cfu/seed).

Results:

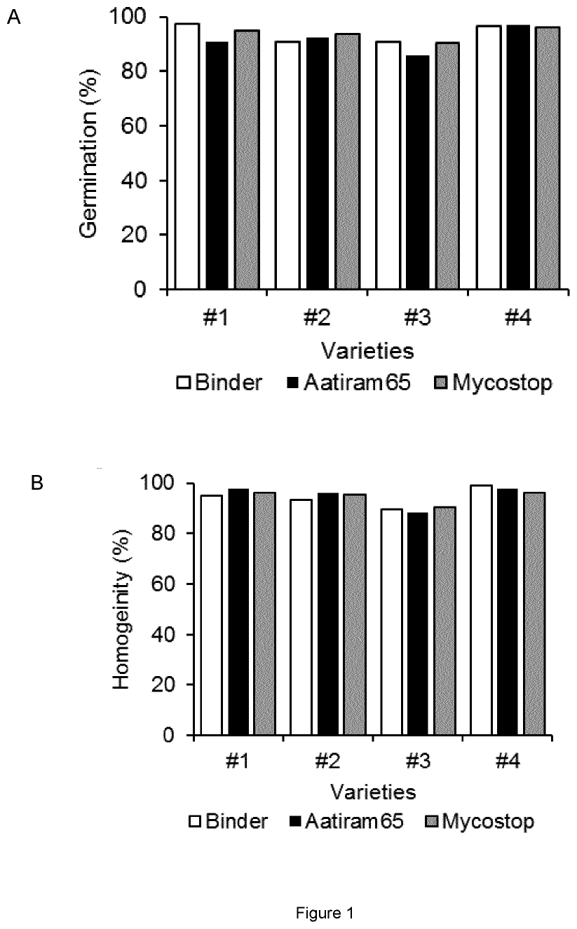

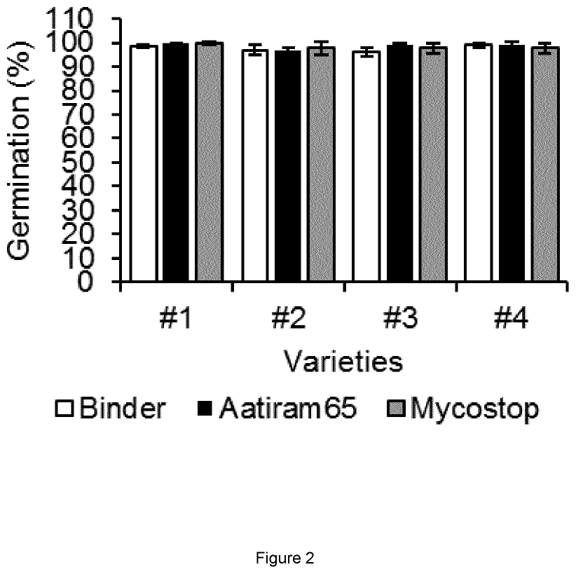

As shown in FIGS. 1 and 2, Mycostop® did not impair the germination and the homogeneity of germination of the four varieties tested.

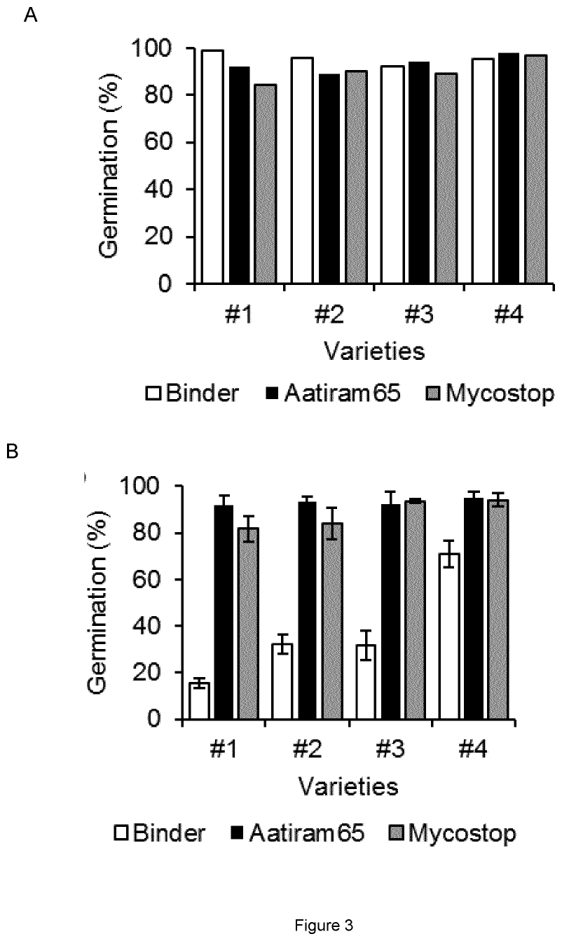

Results described in FIG. 3 also confirmed that Mycostop® was also effective to protect corn salad seedlings against P. valerianellae when the product was applied directly on-seed. The efficacy test was performed in two conditions: clean soil to confirm that the seeds lots were not impaired in their germinating capacity (FIG. 3A) and artificially contaminated soil (FIG. 3 B).

Furthermore, is has been demonstrated that Mycostop® was effective to disinfect corn salad seeds. As presented in the Table 1, Mycostop® was able to prevent the presence of P. valerianellae after the treatment with a level of disinfection that is similar to Aatiram65.

TABLE 1
Efficacy of disinfection treatments
on corn seeds for eradication of
P. valerianellae from corn salad seed

| | Corn | Corn | Corn | Corn |
|---|---|---|---|---|
| | salad | salad | salad | salad |
| | seed | seed | seed | seed |
| Treatments | variety 1 | variety 2 | variety 3 | variety 4 |
| Control | 4.8% | 43.6% | 10.6% | 6.2% |
| Aatiram 65 | 0.0% | 2.0% | 4.0% | 5.6% |
| Mycostop ® | 0.2% | 1.4% | 5.6% | 4.0% |

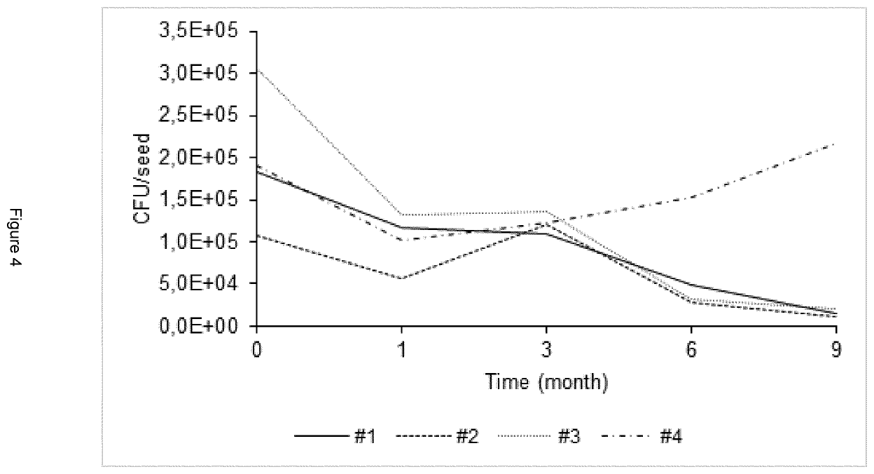

The bacterial population of Streptomyces K61 was stable after nine months (FIG. 4).

### Example 2: Efficacy of Streptomyces Strain K61 as Seed Treatment to Control Phoma Valerianellae on Corn Salad Seeds

The Aatiram 65 (thiram; CHEMINOVA NS) is the reference plant protection product (PPP) used for this study. The Mycostop® (Lallemand Plant Care) product is a powder formulation based on Streptomyces strain K61 (Streptomyces K61) from which the strain can be isolated and grown in a culture medium.

The study was conducted on six different corn salad varieties.

The Streptomyces strain K61 spores isolated from the Mycostop® product in this example were prepared by the solid-state fermentation method described in the materials and methods section.

All tests were performed under controlled conditions (phytotron). The Streptomyces strain K61 spores isolated from the Mycostop® product were compared to seeds treated only with the coating slurry without any PPP (binder) and to the reference chemical Aatiram 65 (Aatiram65).

Seed Coating:

The seed coating with Streptomyces strain K61 spores isolated from Mycostop® and further produced by SSF was performed using a semi-industrial coater (SATEC). The equivalent of five grams of Mycostop® per kg of seeds (dose 1N) were used to coat the corn salad seeds corresponding to the recommendation to this product (2-8 g per kg of seeds). Streptomyces strain K61 spores isolated from Mycostop® were mixed with the adhesive polymer and coated on seeds. The initial concentration of spores coated on the seeds is evaluated at TO and shown in Table 2.

The seed coating with Aatiram65 was performed according to the manufacturer recommendation. After the coating, the corn salad seeds were dried in an air dryer, let stand for one week at room temperature (25° C.) and then used for the selectivity, efficacy and on-seed stability tests.

Selectivity Tests:

After one week of storage, a germinating and homogeneity tests at cold conditions (10° C.) and temperate temperature (15° C.) on filter paper humidified by 16 ml of osmosis water with 16 hours of photoperiod was conducted. 300 seeds were used for the test.

Efficacy Tests Against Phoma valerianellae:

The efficacy test was performed in soil artificially contaminated with P. valerianellae spores. The coated seeds after one week of storage were sown either in contaminated or clean soil. The clean soil served as control of germination rate without pathogen pressure for the seed lots used.

Detection of P. valerianellae in Corn Salad Seeds:

The detection of P. valerianellae in corn salad seeds was performed as described by GEVES (Groupe d'Etude et de Contröle des Variétés Et des Semences) protocol on Agar plate isolation on 1000 seeds. After incubation, contaminated seeds were enumerated.

Determination of the On-Seed Stability:

The on-seed stability of Streptomyces K61 was studied for a period of 6 months. The corn salad seeds were stored at room temperature (i.e. 25° C.). Two samples of seeds per time point were used to study the bacterial population on-seed. The seeds were resuspended in a buffer and the supernatant was used to prepare serial dilutions. The dilutions were plated on the PDA medium and the colonies were expressed as colony-forming units per seed (cfu/seed).

Results:

As shown in FIGS. 1 and 2, Streptomyces K61 (isolated from Mycostop®) did not impair the germination and the homogeneity of germination of the four varieties tested.

Results described in FIG. 3 also confirmed that Streptomyces K61 (isolated from Mycostop®) was also effective to protect corn salad seedlings against P. valerianellae when the product was applied directly on-seed. The efficacy test was performed in two conditions: clean soil to confirm that the seeds lots were not impaired in their germinating capacity (FIG. 3 A) and artificially contaminated soil (FIG. 3 B).

Furthermore, it has been demonstrated that Streptomyces K61 (isolated from (Mycostop®) was effective to disinfect corn salad seeds. As presented in the Table 1A, Streptomyces K61 (isolated from Mycostop®) was able, after seven days of storage after being coated on seeds, to prevent the presence of P. valerianellae after the treatment with a level of disinfection that is similar to Aatiram65.

TABLE 1A
Efficacy of disinfection treatments
on corn seeds for eradication of
P. valerianellae from corn salad seed

| | Corn | Corn | Corn | Corn |
|---|---|---|---|---|
| | salad | salad | salad | salad |
| | seed | seed | seed | seed |
| Treatments | variety 1 | variety 2 | variety 3 | variety 4 |
| Control | 4.8% | 43.6% | 10.6% | 6.2% |
| Aatiram 65 | 0.0% | 2.0% | 4.0% | 5.6% |
| Streptomyces K61 | 0.2% | 1.4% | 5.6% | 4.0% |
| (isolated from | | | | |
| Mycostop ®) | | | | |

Also. As noted in FIG. 4 and Table 2, the bacterial population of Streptomyces K61 was stable after twelve months when stored at room temperature (i.e. 25° C.).

TABLE 2
On-seed stability of Streptomyces K61 spores produced
by SSF stored at 25° C. over a period of 12 months

| | | T0 | T1 M | T3 M | T6 M | T9 M | T12 M |
|---|---|---|---|---|---|---|---|
| Crop | Variety | CFU/seed | CFU/seed | CFU/seed | CFU/seed | CFU/seed | CFU/seed |
| Corn salad | Variety 1 | 1.84E+05 | 1.17E+05 | 1.09E+05 | 4.88E+04 | 1.40E+04 | 8.69E+03 |
| Corn salad | Variety 2 | 1.07E+05 | 5.60E+04 | 1.20E+05 | 2.54E+04 | 1.03E+04 | 5.19E+03 |
| Corn salad | Variety 3 | 3.07E+05 | 1.33E+05 | 1.36E+05 | 3.26E+04 | 2.01E+04 | 4.47E+04 |
| Corn salad | Variety 4 | 1.91E+05 | 1.01E+05 | 1.22E+05 | 1.52E+05 | 2.18E+05 | 2.55E+05 |
| Corn salad | Variety 1 | 1.22E+05 | 9.09E+04 | 5.08E+04 | 2.48E+04 | 3.06E+04 | 2.16E+04 |
| Corn salad | Variety 2 | 1.07E+05 | 7.40E+04 | 4.73E+04 | 1.08E+04 | 1.62E+04 | 1.20E+04 |

### Example 3: Effect of Seed Coating Agents on Spore Germination an/or Viability of Streptomyces K61 Produced by Liquid Submerged Fermentation (LSF) and Solid-State Fermentation (SSF)

The objective of this study was to evaluate the resistance and viability of Streptomyces K61 spores cultivated by LSF and SSF in presence of water, binder and phytosanitary products conventionally used in seed coating formulations.

Spore Production:

Spores of Streptomyces K61 were produced by LSF and SSF as described in the materials and methods section.

Compatibility Assay in Seed Coating Slurries:

As mentioned above, the aim of the assay was to determine the effects of different components included in seed coating formulations on the resistance or viability of spores or Streptomyces K61 produced by LSF and SSF. The spores produced by LSF and SSF were soaked up to 48 hours in the following treatments: (1) water (control); (2) polyethylene glycol (binder) (PEG) (3) polyethylene glycol (binder) and metalaxyl/prothioconazole (Redigo M; fungicide; Bayer); (4) polyethylene glycol (binder) and sedaxane (Vibrance; fungicide; Syngenta) and (5) polyethylene glycol (binder), tefluthrin (Force; insecticide; Syngenta) and Sepiret F290 (seed coating agent; BASF).

The ability of treated spores produced by LSF and SSF to germinate (i.e. the enumeration of viable cells) was determine from appropriate dilutions as colony-forming ability after incubation overnight at 30° C. on nutrient broth agar plates (four Petri dishes/dilution) and was recorded at 0, 6, 24 and 48 hours after the experiment began. Spore concentrations were calculated as the number of colony-forming units (CFU) multiplied by the appropriate dilution factor and expressed as colony-forming units per milliliter (CFU/ml). Each sample was analyzed in duplicate and the enumeration was validated only if the coefficient of variation was inferior at 20%.

Results:

As shown in Table 3, 24 hours after the experiment began, Streptomyces K61 spores produced by LSF did not germinate when in presence of water, polyethylene glycol, metalaxyl/prothioconazole, sedaxane and tefluthrin. Further, there was no germination of spores produced by LSF after six hours in the presence of metalaxyl/prothioconazole and tefluthrin. On the contrary, none of the tested treatments affected Streptomyces K61 spores produced by SSF. In all treatments, they were more resistant than spores produced in LSF. This indicates that spores of Streptomyces K61 produced by LSF do not present a long-term viability once powdered on seeds before sowing. Moreover, the water stored in the soil will directly affect the viability of the spores of Streptomyces K61 produced by LSF.

TABLE 3
Viability of treated Streptomyces K61 spores produced by LSF and SSF 0, 6, 24 and 48 hours after beginning of the experiment

| | T0 h | | | T6 h | | | T24 h | | | T48 h | | |
|---|---|---|---|---|---|---|---|---|---|---|---|---|
| | Spores | Spores | | Spores | Spores | | Spores | | | Spores | | |
| | SSF | LSF | | SSF | LSF | | SSF | Spores | | SSF | Spores | |
| Modality | (CFU/ml) | (CFU/ml) | p-value | (CFU/ml) | (CFU/ml) | p-value | (CFU/ml) | LSF | p-value | (CFU/ml) | LSF | p-value |
| Control (water) | 1E+09 | 2.8E+08 | <1% | 1.0E+09 | 2.0E+07 | <1% | 7.5E+08 | 0 | <1% | 5.5E+08 | 0 | <1% |
| Binder (PEG) | 1.1E+09 | 4.7E+07 | <1% | 9.6E+08 | 2.3E+07 | <1% | 1E+09 | 0 | <1% | 3.9E+08 | 0 | <1% |
| Binder (PEG) + | 1.2E+09 | 3.7E+07 | <1% | 1.0E+09 | 0 | <1% | 9E+08 | 0 | <1% | 7.2E+08 | 0 | <1% |
| Metalaxyl and | | | | | | | | | | | | |
| Prothioconazole | | | | | | | | | | | | |
| Binder (PEG) + | 1.2E+09 | 1.7E+08 | <1% | 1.3E+09 | 4E+07 | <1% | 8.6E+08 | 0 | <1% | NA | 0 | — |
| Sedaxane | | | | | | | | | | | | |
| Binder (PEG) + | 8.2E+08 | 2.6E+07 | <1% | 5.8E+08 | 0 | <1% | 4.6E+08 | 0 | <1% | 3.7E+08 | 0 | <1% |
| Tefluthrin + | | | | | | | | | | | | |
| Sepiret F290 | | | | | | | | | | | | |

### Example 4: Investigation on the On-Seed Stability of Streptomyces K61 Spores Produced by LSF and SSF

The aim of this assay was to determine the on-seed stability of Streptomyces K61 spores produced by LSF and SSF and stored at 15° C. and 30° C.

Spore Production:

Spores of Streptomyces K61 were produced by LSF and SSF as described in the materials and methods section.

On-Seed Compatibility Assay:

Corn seeds (variety Adevey, Limagrain) were used in this assay. Streptomyces K61 spores produced by LSF and SSF were mixed with the following treatments: (1) polyethylene glycol (binder) or (2) a blend of polyethylene glycol (binder), metalaxyl and prothioconazole (Redigo M; fungicide; Bayer), sedaxane (Vibrance; fungicide; Syngenta), tefluthrin (Force; insecticide; Syngenta) and Sepiret F290 (seed coating agent; BASF). A binder was included in the slurry to guaranty a good adherence of the spores on-seed.

The slurries or coating formulations were then applied on-seed using a seed coater. The coating and the coating time (around 30 seconds) were performed according to the standard operating procedures of seed companies. After the coating, the corn seeds were dried in an air dryer. The coated corn seeds were stored at 15° C. and 30° C. for 30 days.

Determination of the On-Seed Stability:

The on-seed stability of Streptomyces K61 was studied for a period of 30 days. One sample of seeds per time point (0, 15 and 30 days) was used to study the bacterial population on-seed (i.e. the enumeration of viable cells). The seeds were resuspended in a buffer and the supernatant was used to prepare serial dilutions. The dilutions were plated on the PDA medium (four Petri dishes/dilution), incubated at 30° C. and the colonies were expressed as colony-forming units per seed (CFU/ml). Each sample was analyzed in duplicate and the enumeration was validated only if the coefficient of variation was inferior at 20%.

Results:

The log bacterial populations of Streptomyces on corn seeds in storage for a period of 30 days are shown in Tables 4 and 5. Survival of spores produced by LSF decreased rapidly at 15° C. (reduction of 3 log) and with increasing storage temperature to 30° C. Indeed, at 30° C., spores produced by LSF did not survive 15 days of storage. Interestingly, for spores produced by SSF, their survival at 15° C. was stable and the population after 30 days of storage was equivalent to the initial population at T0d. At the extreme conditions 30° C., the best survival was recorded with spores produced by SSF. In commercial practice, coated seeds with microorganisms must be stable at room temperature (i.e. 25° C.) because refrigeration is often not possible along the supply chain and is very expensive. Therefore, the spores produced by LSF for coating seeds would definitely be a poor choice whereas the spores produced by SSF demonstrated a greater stability at high temperature.

TABLE 4
On-seed stability of Streptomyces K61 spores produced
by LSF and SSF stored at 15° C. over a period of 30 days

| | T0 d | | | T15 d | | | T30 d | | |
|---|---|---|---|---|---|---|---|---|---|
| | Spores | Spores | | Spores | Spores | | Spores | Spores | |
| | SSF | LSF | | SSF | LSF | | SSF | LSF | |
| Modality | (CFU/ml) | (CFU/ml) | p-value | (CFU/ml) | (CFU/ml) | p-value | (CFU/ml) | (CFU/ml) | p-value |
| Treatment 1 | 4.3E+05 | 2E+05 | NT | 2.14E+05 | 5.50E+03 | <1% | 1.70E+05 | 5.20E+02 | <1% |
| Treatment 2 | 1.4E+05 | 7.7E+04 | NT | 1.55E+05 | 1.60E+03 | <1% | 1.40E+05 | 9.30E+02 | <1% |

TABLE 5
On-seed stability of Streptomyces K61 spores produced
by LSF and SSF stored at 30° C. over a period of 30 days

| | T0 d | | | T15 d | | | T30 d | | |
|---|---|---|---|---|---|---|---|---|---|
| | Spores | Spores | | Spores | Spores | | Spores | Spores | |
| | SSF | LSF | | SSF | LSF | | SSF | LSF | |
| Modality | (CFU/ml) | (CFU/ml) | p-value | (CFU/ml) | (CFU/ml) | p-value | (CFU/ml) | (CFU/ml) | p-value |
| Treatment 1 | 4.3E+05 | 2E+05 | NT | 1.58E+04 | 0 | NT | 1.80E+03 | 0 | NT |
| Treatment 2 | 1.4E+05 | 7.7E+04 | NT | 2.46E+04 | 0 | NT | 2.30E+03 | 0 | NT |

### Example 5: Efficacy of Streptomyces Strain K61 Produced by SSF as Seed Treatment to Control Fusarium oxysporum on Onion, Rhizoctonia solani on Lettuce and Pythium ultimum on Red Beets

The objective of this study was to evaluate whether a seed coating formulation comprising spores of Streptomyces K61 produced by SSF can maintain their viability and functionality/efficacy against crop pathogens after four months of storage at 25° C.

Spore Production:

Spores of Streptomyces K61 were produced by SSF as described in the materials and methods section.

Seed Coating:

Spores of Streptomyces strain K61 produced by SSF were used to coat onion, lettuce and red beet seeds according to the established recommendations. The following treatments have been tested: (1) untreated; (2) Streptomyces K61 spores produced SSF and a binder (polyethylene glycol); and (3) fludioxonil (for R. solani and F. oxysporum) or Metalaxyl-M (for P. ultimum) (Syngenta). The slurries or coating formulations were applied on-seed using a seed coater. The coating and the coating time (around 30 secondes) were performed according to the standard operating procedures of seed companies. After coating, the seeds were dried in a hair dryer. They were stored at room temperature (25° C.) for 4 months.

Efficacy tests against F. oxysporum on onion, R. solani on lettuce and P. ultimum on red beets:

After four months of storage at 25° C., an efficacy test was performed in field and in soil artificially contaminated with F. oxysporum (onion seeds), R. solani (lettuce seeds) and P. ultimum (red beet seeds). The treated coated seeds were sown either in contaminated soils. Two trials were conducted per pathogenic host pair with six replicates of 60 plants per trial. Forty-two days after artificial inoculation, the variable measured was the number of plants attacked for each treatment. The results were expressed as pest incidence which equals to the number of plants attacked by the pathogen.

Results:

After a period of storage of four months at 25° C., the coated seeds with spores of Streptomyces K61 produced by SSF ensured a level of efficacy against F. oxysporum, R. solani and P. ultimum that is similar to that of the chemical treatment tested (Table 6). These results confirm that spores of Streptomyces K61 produced by SSF can maintain their viability and functionality/efficacy against crop pathogens after four months of storage at 25° C.

TABLE 6
Efficacy of spores of Streptomyces K61 produced by SSF on onion, lettuce and
red beet seeds for eradication of F. oxysporum, R. solani and P. ultimum

| | F. oxysporum on onion | | R. solani on lettuce | | P. ultimum on red beet | |
|---|---|---|---|---|---|---|
| | Pest | Statistical | Pest | Statistical | Pest | Statistical |
| Treatment | Incidence | group | Incidence | group | Incidence | group |
| Untreated - | 60.83 | a | 35 | a | 40.28 | c |
| inoculated | | | | | | |
| Fludioxonil or | 30 | b | 15.28 | b | 17.50 | a |
| Metalaxyl-M | | | | | | |
| Spores of K61 | 29.72 | b | 16.94 | b | 17.50 | a |
| produced by SSF | | | | | | |

Means followed by same letter or symbol do not significantly differ (P = .10, Student-Newman-Keuls).
Mean comparisons performed only when AOV Treatment P(F) is significant at mean comparison OSL.

### Example 6: Efficacy of Streptomyces Strain K61 Produced by SSF as Seed Treatment to Control Alternaria brassicicola on Cabbage Seeds and Didymella bryoniae on Squash Seeds

The objective of the study was to evaluate the use of spores of Streptomyces strain K61 produced by SSF as seed treatment to protect cabbage salad seeds against A. brassicicola and squash salad seeds against D. bryoniae

Biocontrol Solutions and Plant Material:

The Aatiram 65 (CHEMINOVA NS) was the reference plant protection product (PPP) used for this study. The spores of Streptomyces strain K61 were produced by SSF as described in the materials and methods section. All tests were performed under controlled conditions (phytotron). Five different varieties of cabbage and two different varieties of squash were tested.

Seed Coating:

Five g of spores of Streptomyces strain K61 produced by SSF per kg of seeds (cabbage and squash seeds) were used to coat the seeds corresponding to the recommendation to this product (2-8 g per kg of seeds). The spores were mixed with polyethylene glycol as a seed coating agent. The seed coating with Aatiram65 was performed according to the manufacturer recommendation. The slurries or coating formulations were then applied on-seed using a seed coater. The coating and the coating time (around 30 seconds) were performed according to the standard operating procedures of seed companies. After the coating, the seeds were dried in a hair dryer, let stand for one week at room temperature (25° C.) and then used for the tests.

Detection of Fungal Pathogens in Cabbage Seeds:

The detection of the three fungal pathogens in the tested seeds is performed as described by GEVES protocol on Agar plate isolation on 1000 seeds. After incubation, contaminated seeds were enumerated.

Results:

As shown in Tables 6 and 7, after a period of storage of one week at 25° C., spores of Streptomyces strain K61 produced by SSF were able to prevent the presence of A. brassicicola and D. bryoniae after the treatment at a level similar to the chemical reference.

TABLE 6
Efficacy of disinfection treatments on cabbage
seeds for eradication of A. brassicicola

| | Variety | Variety | Variety | Variety | Variety |
|---|---|---|---|---|---|
| Treatment | 1 | 2 | 3 | 4 | 6 |
| Control | 0.3% | 2.7% | 3.5% | 8.6% | 14.8% |
| Aatiram 65 | 0.1% | NT | 1.0% | 6.2% | NT |
| Spores of | 0.0% | 0.5% | 0.0% | 1.5% | 3.2% |
| Streptomyces K61 | | | | | |
| produced by SSF | | | | | |

TABLE 7
Efficacy of disinfection treatments on
squash seeds for eradication of D. bryoniae

| | Variety | Variety |
|---|---|---|
| Treatment | 1 | 2 |
| Control | 1.8% | 6.0% |
| Aatiram 65 | 0.4% | 1.5% |
| Spores of | 0.6% | 2.5% |
| Streptomyces K61 | | |
| produced by SSF | | |

While the invention has been described in connection with specific embodiments thereof, it will be understood that the scope of the claims should not be limited by the preferred embodiments set forth in the examples, but should be given the broadest interpretation consistent with the description as a whole.

Further Aspects of the Invention:
1. A method of preparing coated seeds which comprises slurrying (1) seeds, (2) an aqueous suspension comprising at least one seed treatment agent and (3) dry spores of Streptomyces spp.
2. A method for controlling seed-borne pathogens or phytopathogenic microorganisms comprising preparing coated seeds according to the method of aspect 1, and planting said resulting coated seeds, wherein the at least one seed treatment agent comprises an adhesive polymer which is polyvinyl alcohol, polyvinyl alcohol copolymer, methylcellulose, hydroxymethyl cellulose, hydroxymethylpropylcellulose, dextrin, alginate, polyvinylpyrrolidone, vinyl acetate, protein, fats, oils, or any combination thereof.
3. The method according to aspect 1, in which the at least one seed treatment agent is at least one adhesive polymer.
4. The method of aspect 3, wherein said adhesive polymer is polyvinyl alcohol, polyvinyl alcohol copolymer, methylcellulose, hydroxymethyl cellulose, hydroxymethylpropylcellulose, dextrin, alginate, polyvinylpyrrolidone, vinyl acetate, protein, fats, oils, or any combination thereof.
5. The method of any one of aspects 1 to 4, wherein the (3) dry spores of Streptomyces spp. are applied simultaneously with the (1) seeds and the (2) aqueous suspension comprising at least one seed treatment agent.
6. The method of any one of aspects 1 to 5, wherein the (3) dry spores of Streptomyces spp. are applied after slurrying together the (1) seeds with (2) the aqueous suspension comprising at least one seed treatment agent.
7. The method of any one of aspects 1 to 6, further comprising drying the resulting coated seeds.
8. The method of any one of aspects 1 to 7, wherein said aqueous suspension comprises 1% to 55% by weight of the adhesive polymer.
9. The method of any one of aspects 1 to 8, wherein the concentration of Streptomyces spp. spores coated on seeds is from 1×10⁴ to 1×10⁶ CFU/seeds.
10. The method of any one of aspects 1 to 9, wherein the seeds are vegetable seeds, cereal seeds, fruit seeds or leguminous plant seeds.
11. The method of any one of aspects 1 to 10, wherein the coated seeds with dry spores of Streptomyces spp. achieve the same fungicide potency as synthetic chemical product coated on seeds.
12. The method of aspect 11, wherein the coated seeds with dry spores of Streptomyces spp. achieve the same fungicide potency as thiram coated on seeds.
13. The method of aspect 12, wherein the coated seeds with dry spores of Streptomyces spp. achieve the same fungicide potency as thiram coated on seeds against fungal infection caused by seed-borne pathogens.
14. The method of aspect 13, wherein the seed-born pathogen is Phoma valerianellae.
15. A seed coated with dry spores of Streptomyces spp. and at least one seed treatment agent wherein said at least one seed treatment agent comprises an adhesive polymer which is polyvinyl alcohol, polyvinyl alcohol copolymer, methylcellulose, hydroxymethyl cellulose, hydroxymethylpropylcellulose, dextrin, alginate, polyvinylpyrrolidone, vinyl acetate, protein, fats, oils, or any combination thereof.

1.-27. (canceled)

28. A method for:
(i) preparing coated seeds, comprising slurrying seeds and spores of Streptomyces spp produced by solid-state fermentation of the Streptomyces spp; or
(ii) controlling seed-borne pathogens or phytopathogenic microorganisms, comprising preparing coated seeds by slurrying seeds and spores of Streptomyces spp produced by solid-state fermentation of the Streptomyces spp, and planting said resulting coated seeds; or
(iii) using a coated seed comprising spores produced by solid-state fermentation of Streptomyces spp for preventing or reducing the presence of crop pathogens; or
(iv) using spores produced by solid-state fermentation of Streptomyces spp for the preparation of seeds coated with Streptomyces spp. spores; or
(v) using spores produced by solid-state fermentation of Streptomyces spp for enhancing the stability or viability of Streptomyces spp. spores coated on seeds; or
(vi) using a coated seed comprising spores produced by solid-state fermentation of Streptomyces spp for enhancing stability of Streptomyces spp. spores.

29. The method of claim 28, wherein the Streptomyces spp remain substantially stable for at least one month after coating.

30. The method of claim 28, in which the slurry comprises at least one adhesive polymer in an aqueous suspension.

31. The method of claim 30, wherein said adhesive polymer is polyvinyl alcohol, polyvinyl alcohol copolymer, methylcellulose, hydroxymethyl cellulose, hydroxymethylpropylcellulose, dextrin, alginate, polyvinylpyrrolidone, polyethylene glycol, vinyl acetate, protein, fats, oils, or any combination thereof.

32. The method of claim 30, wherein said aqueous suspension comprises 1% to 55% by weight of the adhesive polymer.

33. The method of claim 28, wherein the spores of Streptomyces spp. are applied:
(a) simultaneously with the seeds and an aqueous suspension comprising at least one seed coating agent; or
(b) after slurrying together the seeds with an aqueous suspension comprising at least one seed coating agent.

34. The method of claim 28, further comprising drying the resulting coated seeds.

35. The method of claim 28, wherein the concentration of Streptomyces spp. spores coated on seeds is from about 1×103 to 1×108 CFU/seeds.

36. The method of claim 28, wherein the seeds are vegetable seeds, cereal seeds, fruit seeds or leguminous plant seeds.

37. The method of claim 28, wherein the coated seeds with spores of Streptomyces spp. achieve the same fungicide potency as synthetic chemical product coated on seeds.

38. The method of claim 37, wherein the fungicide potency is against fungal infection caused by:
(a) Phoma, Fusarium, Rhizoctonia, Pythium, Alternaria, Didymella, Macrophomina, Colletotrichum or Aphanomyces; or
(b) Fusarium oxysporum, Rhizoctonia solani, Pythium ultimum, Alternaria brassicicola or Didymella bryoniae.

39. The method of claim 37, wherein the synthetic chemical product is thiram.

40. The method of claim 39, wherein the fungicide potency is against fungal infection caused by seed-borne pathogens, optionally wherein the seed-born pathogen is Phoma valerianellae.

41. A seed coated with spores of Streptomyces spp. produced by solid-state fermentation of the Streptomyces spp, optionally wherein the seed is obtainable by the method of claim 28.

42. The seed of claim 41, wherein said coating comprises an adhesive polymer which is polyvinyl alcohol, polyvinyl alcohol copolymer, methylcellulose, hydroxymethyl cellulose, hydroxymethylpropylcellulose, dextrin, alginate, polyvinylpyrrolidone, polyethylene glycol, vinyl acetate, protein, fats, oils, or any combination thereof.

43. A liquid suspension for coating seeds, comprising spores of at least one Streptomyces spp. produced by solid-state fermentation of Streptomyces spp, optionally wherein the seed is obtainable by the method of claim 28.

44. The method of claim 28, wherein:
(a) the Streptomyces spp is the Streptomyces spp. strain K61 (deposited under accession number DSM 7206); or
(b) the spores are dry spores, optionally wherein the Streptomyces spp is the Streptomyces spp. strain K61 (deposited under accession number DSM 7206).

45. The seed of claim 36, wherein:
(a) the Streptomyces spp is the Streptomyces spp. strain K61 (deposited under accession number DSM 7206); or
(b) the spores are dry spores, optionally wherein the Streptomyces spp is the Streptomyces spp. strain K61 (deposited under accession number DSM 7206).

46. The liquid suspension of claim 43, wherein:
(a) the Streptomyces spp is the Streptomyces spp. strain K61 (deposited under accession number DSM 7206); or
(b) the spores are dry spores, optionally wherein the Streptomyces spp is the Streptomyces spp. strain K61 (deposited under accession number DSM 7206).
